(19) United States
(12) Patent Application Publication
(10) Pub. No.: US 2010/0292036 A1
(43) Pub. Date: Nov. 18, 2010

(54) TENSIONING DEVICE FOR THE TRACTION MECHANISM DRIVE IN A TIMING SYSTEM ON A MOTOR VEHICLE

(75) Inventors: Marco Kowalski, Herzogenaurach (DE); Roman Kern, Forchheim (DE); Andreas Hempfling, Nuernberg (DE); Sebastian Block, Memmelsdorf (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, HERZOGENAURACH (DE)

(21) Appl. No.: 12/864,256

(22) PCT Filed: Dec. 9, 2008
(86) PCT No.: PCT/EP08/67095

§ 371 Date: Jul. 23, 2010

(30) Foreign Application Priority Data
Jan. 24, 2008 (DE) 10 2008 005 764.9

(51) Int. Cl. F16H 7/08

(52) U.S. Cl. 474/110

(57) ABSTRACT

A tensioning device for the endless drive in a timing system on a motor vehicle, which has a tensioning piston that can move along a path axis in a housing, within which a pressure chamber is located which houses a working medium which brings about a movement of the tensioning piston in the housing and has a valve seat, connected to the exterior of the tensioning piston by an outlet and accommodating a valve body essentially matching the shape of the valve seat. The valve body is tapered along the axial path axis to the outlet, which allows for a large chamber between the valve body and the valve seat. The path that the working medium, on bleeding gas bubbles from the same, takes from the pressure chamber to the outlet is longer, which increases the hydraulic resistance and restricts and limits emptying of working medium from the tensioning piston.

### FIELD OF THE INVENTION

The invention relates to a tensioning device for traction mechanism drives in the timing system of a motor vehicle, comprising a tensioning piston which is displaceable in a housing along a path axis, in the interior of which tensioning piston is located a pressure chamber accommodating a working medium which brings about the displacement of the tensioning piston in the housing, which pressure chamber has a valve seat which is connected via at least one outlet to the exterior of the tensioning piston and receives a valve body substantially matching the shape of the valve seat.

### BACKGROUND OF THE INVENTION

Tensioning devices of the type mentioned in the introduction are known and are used in many technical fields. One of these fields is motor vehicle technology, where they counteract slack in a traction means, usually in the form of a chain or belt, in that a tensioning piston which is displaceable in a housing along a path axis of the tensioning device exerts a pressure on the traction means, thereby maintaining it under tension.

The pressure generated by the tensioning device may be generated in various ways. A means frequently adopted in practice makes use of hydraulic means. In this case, a pressure chamber is formed within the tensioning piston and accommodates a working medium, usually present in the form of a hydraulic oil, which presses against the tensioning piston. Pressurization of the hydraulic oil causes pressure to be applied to the tensioning piston, which the latter can transmit to the traction means.

A problem which often arises in connection with hydraulic oils concerns the presence of gas therein. The gas, usually present in the form of air, can enter the hydraulic oil through leaks in the oil circuit or as a result of foaming phenomena and is entrained by the oil in the form of bubbles. When these air-containing bubbles enter the tensioning device they impair its operation since, as a result of the considerably higher compressibility of air in comparison to the hydraulic oil, pressurization of the hydraulic oil leads to lower and/or time-delayed pressurization of the tensioning piston and therefore of the traction means.

In order to solve this problem, use is generally made of valves which are arranged between the pressure chamber and an outlet leading to the outside. In their simplest form, these valves comprise a valve seat on which a valve body is seated. Such an arrangement is disclosed in the German utility model DE 202 10 622 U1. In this case the recess and the base of a tensioning piston serve as the valve seat, into which a cap serving as the valve body is pressed in such a manner that the cap bears form-fittingly against the recess and the base. This cap receives a filling body on the end face of which is formed radial venting channels oriented perpendicularly to the longitudinal extent of the tensioning device, via which channels gas can be removed from the hydraulic oil.

A further generic hydraulic chain tensioner is disclosed by DE 44 31 161 A1, which tensioner has a chamber of a housing filled with a hydraulic working medium, and includes a hollow plunger which is arranged slidingly in the chamber and has an opening at its upper end, together with a spring which urges the plunger axially outwards. In order to deaerate the hydraulic oil it is provided that a venting means in the form of a disk is arranged in the region of the opening of the plunger and is provided, on at least one end face, with a channel via which a site on the circumference of the disk is connected to a site via which a connection between the ambient atmosphere and the chamber can be established through the opening mentioned. In this case, the channel may have a spiral or meandering configuration, or may be configured with a different geometry.

Characteristic of the use of valves of this construction in tensioning devices of the type mentioned in the introduction are two aspects which conflict with one another. According to the first aspect, the space between the valve body and the valve seat must be large enough for air to escape from the pressure chamber as quickly as possible through the space to the outlet; according to the second aspect, the space between the valve body and the valve seat must not be dimensioned too large, since otherwise too much hydraulic oil escapes from the tensioning device through the space and via the outlet, necessitating relatively frequent replenishing of the tensioning device with hydraulic oil and detrimentally affecting the leakage properties of the tensioning device.

### OBJECT OF THE INVENTION

It is the object of the invention to provide a tensioning device of the type mentioned in the introduction in which the space between the valve body and the valve seat is dimensioned such that air contained in the hydraulic pressure chamber can be discharged rapidly to the outside and at the same time the outflow of hydraulic oil from the tensioning device is impeded and retarded.

### SUMMARY OF THE INVENTION

The starting point of the invention is a tensioning device for traction mechanisms in the timing system of a motor vehicle, comprising a tensioning piston which is displaceable in a housing along a path axis, in the interior of which tensioning piston is formed a pressure chamber accommodating a working medium which brings about the displacement of the tensioning piston in the housing, which pressure chamber has a valve seat which is connected via at least one outlet to the exterior of the tensioning piston and receives a valve body substantially matching the shape of the valve seat. According to the invention the tensioning device is distinguished by the fact that the valve body tapers along the path axis in the direction of the outlet.

The inventive tapering of the valve body makes it possible for the valve body to be configured with greater volume than is the case with tensioning devices according to the prior art. The larger volume causes the space between the valve body and the valve seat to be longer. The distance the hydraulic oil travels from the pressure chamber to the outlet thereby becomes longer. The longer distance in turn puts up a greater hydraulic resistance to the flowing hydraulic oil, for which reason less oil reaches the outlet and, through it, the environment during degassing of the pressure chamber. The leakage properties of the tensioning device are therefore improved.

The tapering of the valve body towards the path axis may be implemented by numerous shapes of the valve body. Thus, in preferred exemplary embodiments of the invention, the valve body has a conical, frustoconical, spherical or frustospherical configuration. These shapes have the advantage that they are rotationally symmetrical, which simplifies their production.

However, the shapes of the valve body are not limited to rotationally symmetrical configurations. In the case of a tensioning piston which, viewed in the direction of the path axis of the tensioning device, has a rectangular cross section and therefore is not rotationally symmetrical, the valve body located in the tensioning piston may have a pyramidal or frustopyramidal configuration.

With the tensioning device according to the invention, further measures can be taken to impede and retard the outflow of hydraulic oil from the pressure chamber. For example, in a preferred exemplary embodiment, the valve body has a surface in which at least one passage is formed such that a connecting path exists between the pressure chamber and the outlet. The at least one passage allows air present in the hydraulic oil to pass towards the outlet while putting up flow resistance to the hydraulic oil and thus impeding or retarding its outflow. In practice, the passage is in the form of a groove or channel milled or molded into the surface of the valve body.

The same effect is achieved with the complementary geometric configuration of the valve seat, in comparison to the last-mentioned exemplary embodiment. Thus, in a further preferred exemplary embodiment, the valve seat has a surface in which at least one passage is formed such that a connecting path exists between the pressure chamber and the outlet. In this configuration, too, the air contained in the hydraulic oil can pass through the at least one passage while the outflow of hydraulic oil through the passage is impeded and retarded. In this exemplary embodiment the passage is a groove or channel which, contrary to the last-mentioned exemplary embodiment, is milled or molded into the surface of the valve seat.

A combination of the two last-mentioned exemplary embodiments is also possible. In this combination at least one passage each is formed in the surface of the valve body and in the surface of the valve seat.

The at least one passage in the surface of the valve body and/or of the valve seat may be configured in very diverse ways. In preferred exemplary embodiments, the passage makes available a spiral, sinuous, meandering or zigzag connecting path between the pressure chamber and the outlet. All these configurations of the passage lengthen the connecting path between the pressure chamber and the outlet. The flow resistance put up to the hydraulic oil is thereby increased, additionally impeding and retarding the outflow of the hydraulic oil. The configurations of the passage listed represent regular patterns and can therefore be formed simply in the surface of the valve body and/or of the valve seat.

If a plurality of passages are formed in the surface of the valve body and/or of the valve seat, these may each provide a connecting path between the pressure chamber and the outlet independently of one another. However, they may also be interconnected, as is the case in a further preferred exemplary embodiment. In this way, a labyrinthine structure is formed on the surface of the valve body and/or of the valve seat.

Through the pressure prevailing in the pressure chamber, the valve body is pressed into the valve seat during operation of the tensioning device. Measures may be taken to further improve the arresting of the valve body on the valve seat. For example, in a further exemplary embodiment, the valve body is provided with a projection extending into the outlet of the valve seat. The projection arrests the valve body in the valve seat. For example, it prevents a rotationally symmetrical valve body from moving freely in the pressure chamber.

### BRIEF DESCRIPTION OF THE DRAWING

The invention is explained in more detail below with reference to an exemplary embodiment and to the appended drawing, in which:

FIG. 1 is a schematic representation of a tensioning device according to the invention;

FIG. 2 is a detailed representation of a tensioning piston of the tensioning device of FIG. 1 in a longitudinal sectional view, and

FIG. 3 is a detailed representation of a valve body according to the invention in a longitudinal sectional view.

### DETAILED DESCRIPTION OF THE DRAWING

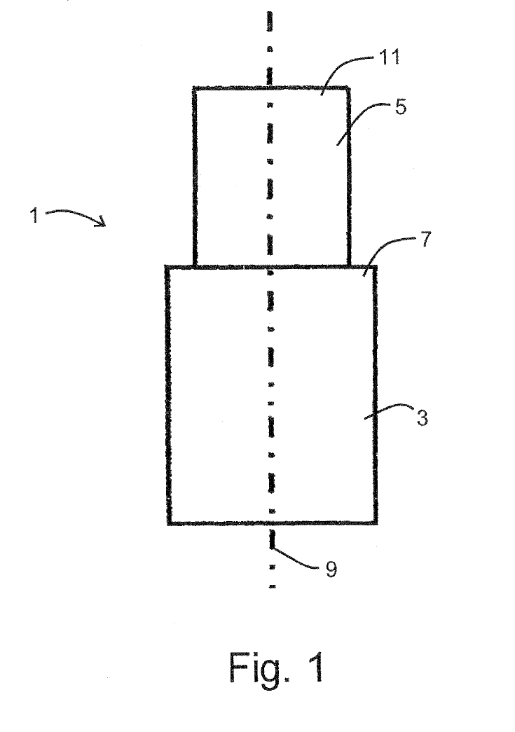

Accordingly, FIG. 1 shows schematically a tensioning device 1 according to the invention. The tensioning device 1 comprises two main components, namely a housing 3 and a tensioning piston 5. The tensioning piston 5 projects from the housing 3 at an end 7 thereof and is displaceable in the housing 3 along a path axis 9. Both the housing 3 and the tensioning piston 5 are configured as cylinders, which are therefore rotationally symmetrical with respect to the path axis 9 of the tensioning device 1. The tensioning piston 5 exerts via a tensioning rail (not shown) a pressure on a traction means (not shown) which is located in the environment of its end 11 projecting from the housing 3. The traction means is tensioned by this pressure.

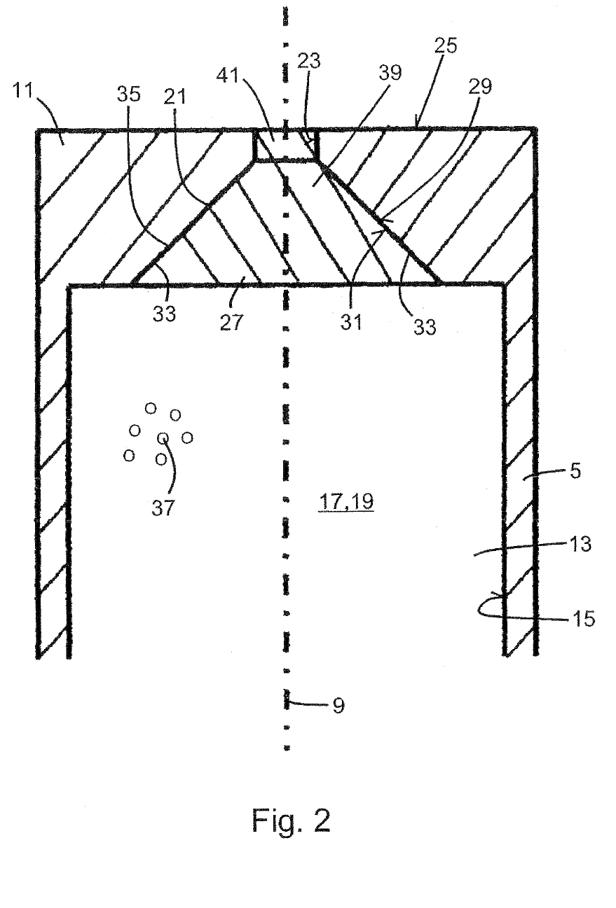

A section through the end 11 of the tensioning piston 5 which projects from the housing 3 is shown in FIG. 2. Formed in the interior 13 of the tensioning piston 5 is a pressure chamber 15 which occupies a major part of the interior 13 of the tensioning piston 5. The pressure chamber 15 accommodates a working medium 17 in the form of a hydraulic oil 19, which completely fills the pressure chamber 15. The pressure chamber 15 is connected to the exterior 25 of the tensioning piston 5 via a valve seat 21 and an outlet 23. A valve body 27 is received in the valve seat 21.

FIG. 2 shows that the shape of the valve body 27 matches the shape of the valve seat 21; that is to say that a surface 29 of the valve body 27 rests against a surface 31 of the valve seat 21. Although the shape of the valve body 27 matches the shape of the valve seat 21 and their surfaces 29 and 31 rest against one another, a small space 33 remains between the two surfaces 29 and 31. This space 33 ensures that a connecting path 35 is present between the pressure chamber 15 and the outlet 23, in order to remove gas 37 from the pressure chamber 15.

FIG. 2 also makes clear that the valve body 27 tapers towards the outlet 23 along the path axis 9. When the tensioning piston 5 is viewed from above, this means that sections taken through the valve body 27 perpendicularly to the drawing plane of FIG. 2 and to the path axis 9 of the tensioning piston 5 decrease in diameter from the pressure chamber 15 to the outlet 23, that is, from below to above in FIG. 2. There are numerous geometrical shapes which satisfy the above-mentioned tapering property. FIG. 2 shows one of the shapes which occur most frequently in practice; here, the valve body 27 and, because of the matching shapes of the valve body 27 and the valve seat 21, also the valve seat 21 have a conical configuration.

The operation of the tensioning device 1 according to the invention is explained below with reference to FIG. 2.

To enable the tensioning device 1 to exert a pressure on the traction means (not shown), the hydraulic oil 19 in the pressure chamber 15 is pressurized. The pressure causes the tensioning piston 5 to be displaced in the housing 3 along the path axis 9 of the tensioning device 1. The displacement of the tensioning piston 5 in turn causes a pressure to be applied to the traction means.

It is frequently the case that, because of leaks in the oil circuit or as a result of foaming phenomena within the hydraulic oil 19, gas penetrates the oil 15. The gas, usually air, is entrained in the oil 19 in the form of bubbles 37 and thus enters the pressure chamber 15 of the tensioning piston 5. Because the air is far more compressible than the hydraulic oil 15, the presence of the air impedes and retards the displacement of the tensioning piston 5 in the housing 3. In order to counteract this disadvantageous effect, the air is conducted out of the pressure chamber 15. FIG. 2 makes clear how this takes place. The bubbles 37 present in the pressure chamber 15 reach the end 11 of the tensioning piston 5 within the pressure chamber 15, then enter the space 33 formed by the surface 29 of the valve body 27 and the surface 31 of the valve seat 21, migrate in the space 33 to the outlet 23 of the tensioning piston 5 and reach the exterior 25 of the tensioning piston 5 through the outlet 23.

Because of the pressure prevailing in the pressure chamber 15, the hydraulic oil 15 is also forced into the space 33 between the valve seat 21 and the valve body 27 and from there via the outlet 23 to the exterior 25 of the tensioning piston 5. However, because of the conical configuration of the valve body 27, the connecting path 35 is comparatively long, for which reason a comparatively high resistance is put up to the hydraulic oil 19 flowing through the connecting path 35. The egress of the hydraulic oil 19 from the pressure chamber 15 is thereby impeded and retarded.

The conical valve body 27 is provided in the region of its tip 39 with a projection 41 which extends into the outlet 23 of the tensioning piston 5. The projection 41 brings about an arresting of the valve body 27 in the valve seat 21. The projection 41 prevents the valve body 27 from moving freely in the pressure chamber 15 when the tensioning device 1 is not in operation.

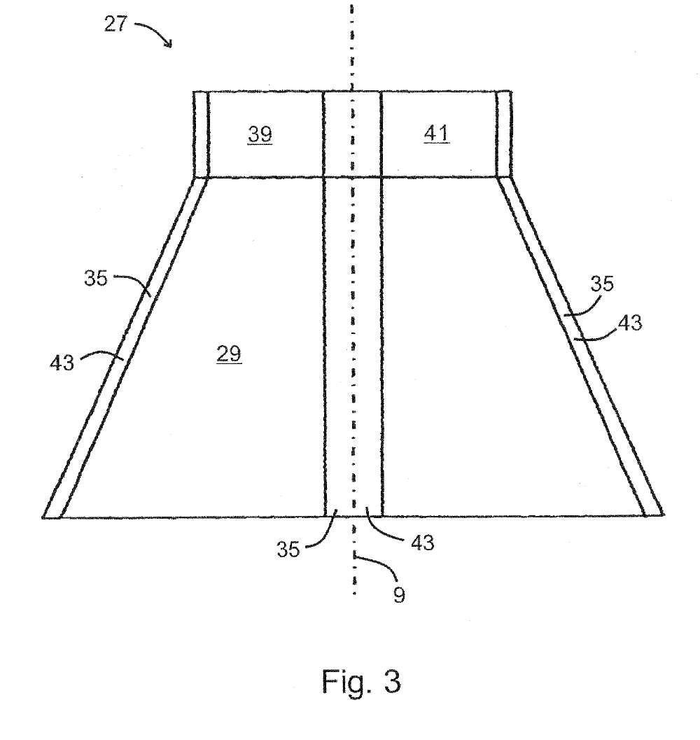

FIG. 3 shows a preferred exemplary embodiment of the valve body 27. Four passages 43, three of which are visible in FIG. 3, are formed in the surface 29 of the valve body 27. The passages 43 establish a further connecting path 35 from the pressure chamber 15 to the outlet 23 and from there to the exterior 25 of the tensioning piston 5, in addition to the space 33 between the valve body 27 and the valve seat 21. The passages 43 are a further means for removing gas 37 from the pressure chamber 15. The passages 43 are in the form of grooves milled or molded into the surface 29 of the valve body 27.

In the exemplary embodiment of the valve body 27 of FIG. 3, the passages 43 lead rectilinearly on the surface 29 of the valve body 27 from the pressure chamber 15 to the outlet 23 and are not interconnected.

Because the entire surface 29 of the valve body 27 is available for the introduction of passages 23, numerous other configurations of the passages are possible. For example, the passages may have a spiral, sinuous, meandering or zigzag configuration. In addition, the passages may be interconnected in any desired manner, so that labyrinthine structures are formed on the surface 29 of the valve body 27.

It is clear from the above that, with the inventive tensioning device, a greater hydraulic resistance is put up to the hydraulic oil 19 flowing via the means provided for deaeration, whereby the outflow of the oil from the tensioning device is impeded and retarded. This improves the leakage properties of the tensioning device.

### LIST OF REFERENCES

1 Tensioning device
3 Housing
5 Tensioning piston
7 End of housing
9 Path axis
11 End of tensioning piston
13 Interior of tensioning piston
15 Pressure chamber
17 Working medium
19 Hydraulic oil
21 Valve seat
23 Outlet
25 Exterior of tensioning piston
27 Valve body
29 Surface of valve body
31 Surface of valve seat
33 Space
35 Connecting path
37 Bubbles
39 Tip of valve body
41 Projection
43 Passage

1. A tensioning device for traction mechanism drives in the timing system of a motor vehicle, comprising:
a tensioning piston which is displaceable in a housing along a path axis, in an interior of the tensioning piston is formed a pressure chamber accommodating a working medium which brings about the displacement of the tensioning piston in the housing, the pressure chamber has a valve seat which is connected via at least one outlet to an exterior of the tensioning piston and receives a valve body substantially matching a shape of the valve seat,
wherein the valve body tapers along the path axis in a direction of the outlet.

2. The tensioning device of claim 1, wherein the valve body has a conical, frustoconical, spherical, frustospherical, pyramidal or frustopyramidal configuration.

3. The tensioning device of claim 1, wherein the valve body has a surface in which at least one passage is formed such that a connecting path exists between the pressure chamber and the outlet.

4. The tensioning device of claim 1, wherein the valve seat has a surface in which at least one passage is formed such that a connecting path exists between the pressure chamber and the outlet.

5. The tensioning device claim 3, wherein the at least one passage, which has a groove-shaped cross-section, is formed on the valve body and/or on the valve seat with a spiral, sinuous, meandering or zigzag configuration.

6. The tensioning device of claim 1, wherein a plurality of passages on the valve body and/or on the valve seat are interconnected.

7. The tensioning device of claim 1, wherein the valve body has an axial projection extending into the outlet.

8. The tensioning device claim 4, wherein the at least one passage, which has a groove-shaped cross-section, is formed on the valve body and/or on the valve seat with a spiral, sinuous, meandering or zigzag configuration.
